(19) United States
(12) Patent Application Publication
(10) Pub. No.: US 2015/0017974 A1
(43) Pub. Date: Jan. 15, 2015

(54) MOBILE STATION AND RADIO BASE STATION

(71) Applicant: NTT DOCOMO, INC., Tokyo (JP)

(72) Inventors: Kenichiro Aoyagi, Tokyo (JP); Tooru Uchino, Tokyo (JP); Yuichiro Nakamura, Tokyo (JP)

(73) Assignee: NTT DOCOMO, INC., Tokyo (JP)

(21) Appl. No.: 14/378,040

(22) PCT Filed: Mar. 13, 2013
(86) PCT No.: PCT/JP2013/057071

§ 371 Date: Aug. 11, 2014

(30) Foreign Application Priority Data
Mar. 14, 2012 (JP) 2012-057443

(51) Int. Cl. H04W 76/06

(52) U.S. Cl. CPC H04W 76/06
USPC 455/422.1

(57) ABSTRACT

Avoided is hasty control occurring due to repetition of transition to a “Preservation state” and return to an “Active state.” A mobile station UE according to the present invention includes: a transmission unit 13 configured to transmit “SIGNALLING CONNECTION RELEASE INDICATION” commanding release of signalling connection to a radio access network upon detecting that there is no more data to be transmitted; and a determination unit 12 configured to determine whether the mobile station UE is in a particular state or not. The transmission unit 13 is configured to keep the “SIGNALLING CONNECTION RELEASE INDICATION” from being transmitted to the radio access network if the determination unit 12 determines that the mobile station UE is in the particular state, even when the transmission unit 13 detects that there is no more data to be transmitted.

### TECHNICAL FIELD

The present invention relates to a mobile station and a radio base station.

### BACKGROUND ART

3GPP specifies “Fast Dormancy function” for the purpose of saving the battery of a mobile station UE (see Non-patent document 1).

According to the “Fast Dormancy function,” the mobile station UE is configured to, upon detecting that there is no more data to be transmitted, transmit “SIGNALLING CONNECTION RELEASE INDICATION” to a radio access network (a radio base station eNB) so that the mobile station UE can transition to a “Preservation state” immediately.

Here, the radio access network (the radio base station eNB) can control the intervals at which the mobile station UE retransmits the “SIGNALLING CONNECTION RELEASE INDICATION,” by notifying the mobile station UE of a value of a timer T323.

### PRIOR ART DOCUMENT

### Patent Document

Non-patent document 1: 3GPP TS25.331 CHAPTER 8.1.14

### SUMMARY OF THE INVENTION

Since the mobile station UE transitions to the “Preservation state,” the existing “Fast Dormancy function” can be expected to produce effects of suppressing consumption of the battery of the mobile station UE and radio resources. On the other hand, as shown in FIG. 5, when the mobile station UE frequently transitions to the “Preservation state” and then returns to an “Active state,” such as when a user is browsing on the mobile station UE, there arises a problem that the mobile station UE inevitably performs hasty control due to the repetition of transition and return.

The existing “Fast Dormancy function” also has a problem that the radio access network (the radio base station eNB) can only control the intervals at which the mobile station UE retransmits the “SIGNALLING CONNECTION RELEASE INDICATION,” and each mobile station UE cannot avoid the hasty control occurring due to the repetition of transition and return.

Thus, the present invention has been made in view of the above problems, and has an objective of providing a mobile station and a radio base station capable of avoiding hasty control occurring due to repetition of transition to a “Preservation state” and return to an “Active state.”

A first feature of the present invention is summarized as a mobile station including: a transmission unit configured to transmit a release indication signal to a radio base station upon detecting that there is no more data to be transmitted, the release indication signal commanding release of signalling connection; and a determination unit configured to determine whether the mobile station is in a particular state or not. Here, the transmission unit is configured to keep the release indication signal from being transmitted to the radio base station if the determination unit determines that the mobile station is in the particular state, even when the transmission unit detects that there is no more data to be transmitted.

A second feature of the present invention is summarized as a mobile station including a transmission unit configured to transmit a release indication signal to a radio access network upon detecting that there is no more data to be transmitted, the release indication signal commanding release of signalling connection. Here, the transmission unit is configured to keep the release indication signal from being transmitted to the radio access network until a predetermined period passes after transmission of a connection request signal, even when the transmission unit detects that there is no more data to be transmitted.

A third feature of the present invention is summarized as a radio base station capable of communicating with a mobile station configured to determine, based on whether the mobile station is in a particular state or not, whether or not to transmit a release indication signal commanding release of signalling connection upon detecting that there is no more data to be transmitted, the radio base station including a transmission unit configured to notify the mobile station of determination information via notification, the determination information being for the determination on whether or not the mobile station is in the particular state or not.

A fourth feature of the present invention is summarized as a radio base station capable of communicating with a mobile station configured to keep a release indication signal commanding release of signalling connection from being transmitted until a predetermined period passes after transmission of a connection request signal even upon detecting that there is no more data to be transmitted, the radio base station including a transmission unit configured to notify the mobile station of the predetermine period via notification.

### BRIEF DESCRIPTION OF THE DRAWINGS

FIG. 1 is an overall configuration diagram of a mobile communication system according to a first embodiment of the present invention.

FIG. 2 is a functional block diagram of a mobile station according to the first embodiment of the present invention.

FIG. 3 is a functional block diagram of a radio base station according to the first embodiment of the present invention.

FIG. 4 is a sequence diagram showing operation of the mobile communication system according to the first embodiment of the present invention.

FIG. 5 is a diagram illustrating problems in a conventional mobile communication system.

### MODE FOR CARRYING OUT THE INVENTION

### (Mobile Communication System According to First Embodiment of the Present Invention)

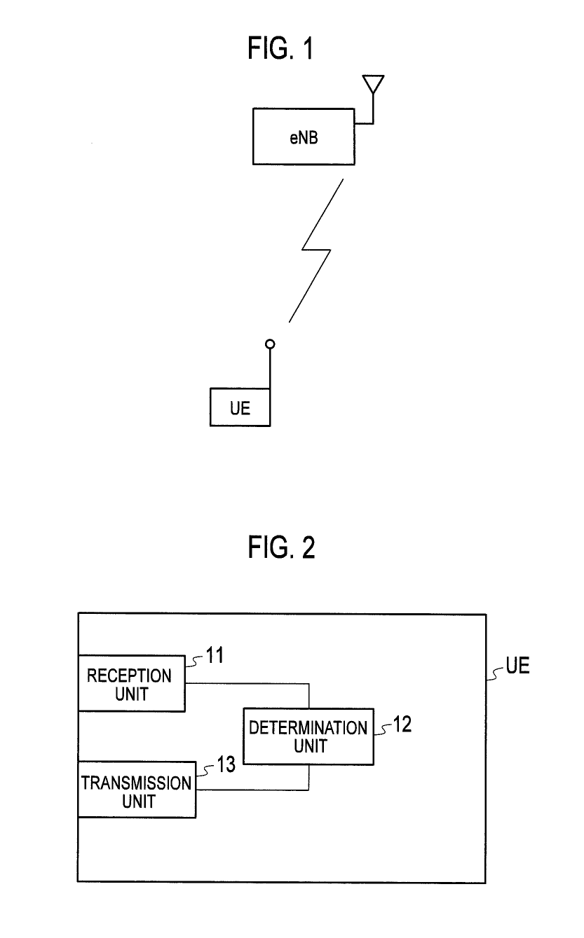

With reference to FIGS. 1 to 4, a description is given of a mobile communication system according to a first embodiment of the present invention.

The mobile communication system of this embodiment may be an LTE (Long Term Evolution) mobile communication system, a WCDMA (Wideband CDMA) mobile communication system, or a mobile communication system employing other radio access network scheme.

Although this embodiment describes an LTE mobile communication system as an example, the present invention is applicable to other than the LTE mobile communication system, as well. The mobile communication system according to this embodiment includes, as shown in FIG. 1, a radio base station eNB and a mobile station UE.

As shown in FIG. 2, the mobile station UE according to this embodiment includes a reception unit 11, a determination unit 12, and a transmission unit 13.

The reception unit 11 is configured to receive various signals from a radio access network, i.e., the radio base station eNB, and the transmission unit 13 is configured to transmit various signals to the radio access network, i.e., the radio base station eNB.

The determination unit 12 is configured to determine whether the mobile station UE is in a particular state or not.

For example, the determination unit 12 may be configured to determine that the mobile station UE is in the particular state when determining that the mobile station UE is in a state of performing data exchange accompanied by user operation (e.g., a user is browsing on the mobile station UE).

The determination unit 12 may also be configured to determine that the mobile station UE is in the particular state when determining that the mobile station UE is in a state of performing data exchange not accompanied by user operation (e.g., the mobile station UE is performing periodic data exchange such as “Keep Alive signal” by an application).

The determination 12 may be configured to determine whether the mobile station UE is in the particular state or not based on a data amount (determination information) predetermined by the radio access network (the radio base station eNB).

For example, the determination unit 12 may be configured to determine that the mobile station UE is in the state of performing data exchange not accompanied by user operation or that the mobile station UE is not in the particular state, when the amount of data exchanged after transition of the mobile station UE to the “Active State” is smaller than the predetermined data amount.

Alternatively, the determination unit 12 may be configured to determine that the mobile station UE is in the state of performing data exchange accompanied by user operation or that the mobile station UE is in the particular state, when the amount of data exchanged after transition of the mobile station UE to the “Active State” is larger than the predetermined data amount.

Note that the determination unit 12 may be configured to be notified of such determination conditions by the radio access network (the radio base station eNB).

The determination unit 12 may also be configured to determine whether the mobile station UE is in the particular state or not based on a transmission interval (determination information) predetermined by the radio access network (the radio base station eNB).

For example, the determination unit 12 may be configured to determine that the mobile station UE is in the particular state when a period of time equivalent to the transmission interval has not passed yet after transition of the mobile station UE to the “Active state.”

Note that the determination unit 12 may be configured to be notified of such determination conditions by the radio access network (the radio base station eNB). A timer managing this transmission interval is different from the timer T323 described earlier.

Further, the determination unit 12 may also be configured to determine whether the mobile station UE is in the particular state or not based on a data type (determination information) predetermined by the radio access network (the radio base station eNB).

For example, the determination unit 12 may be configured to determine that the mobile station UE is not in the particular state when determining that the type of last data transmitted by the mobile station UE after transition of the mobile station UE to the “Active state” is periodic data such as “Keep Alive signals” by an application.

Alternatively, the determination unit 12 may be configured to determine that the mobile station UE is in the particular state when determining that the type of last data transmitted by the mobile station UE after transition of the mobile station UE to the “Active state” is data for browsing.

Note that the determination unit 12 may be configured to be notified of such determination conditions by the radio access network (the radio base station eNB).

When the mobile station UE uses the “Fast Dormancy function,” the transmission unit 13 is basically configured to transmit “SIGNALLING CONNECTION RELEASE INDICATION” to the radio access network (the radio base station eNB) upon detecting that there is no more data to be transmitted.

However, even when the mobile station UE uses the “Fast Dormancy function,” the transmission unit 13 is configured to keep “SIGNALLING CONNECTION RELEASE INDICATION” from being transmitted to the radio access network (the radio base station eNB) if the determination unit 12 determines that the mobile station UE is in the particular state, even when the transmission unit 13 detects that there is no more data to be transmitted.

The transmission unit 13 may be configured to keep the “SIGNALLING CONNECTION RELEASE INDICATION” from being transmitted to the radio access network (the radio base station eNB) until a predetermined period passes after the transmission unit 13 transmits “RRC CONNECTION REQUEST,” even when the transmission unit 13 detects that there is no more data to be transmitted and when the determination unit 12 determines that the mobile station UE is not in the particular state.

Note that the transmission unit 13 is configured to be notified of the predetermined period by the radio access network (radio base station eNB) via notification.

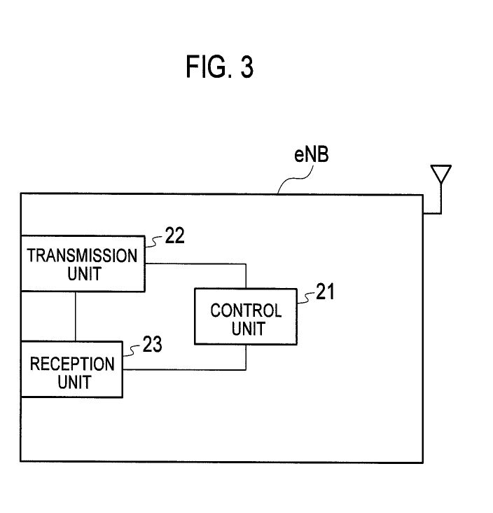

As shown in FIG. 3, the radio base station eNB according to this embodiment includes a control unit 21, a transmission unit 22, and a reception unit 23.

The transmission unit 22 is configured to transmit various signals to the mobile station UE, and the reception unit 23 is configured to receive various signals from the mobile station UE.

For example, the transmission unit 22 may be configured to notify the mobile station UE of the above-described determination information such as the data amount, the transmission interval and the data type, the above-described determination conditions, the predetermined period and the like, via notification.

The reception unit 23 is configured to receive the “SIGNALLING CONNECTION RELEASE INDICATION,” the “RRC CONNECTION REQUEST,” and the like from the mobile station UE.

The control unit 21 is configured to perform various kinds of control in the radio base station eNB.

For example, the control unit 21 may be configured to determine whether or not to make the mobile station UE transition to the “Preservation state” when the reception unit 23 receives “SIGNALLING CONNECTION RELEASE INDICATION” from the mobile station UE.

Then, when the control unit 21 determines that the mobile station UE should transition to the “Preservation state,” the transmission unit 22 and the reception unit 23 are configured to perform processing in collaboration with the mobile station UE for making the mobile station UE transition to the “Preservation state” (specifically, processing for releasing signalling connection of the mobile station UE).

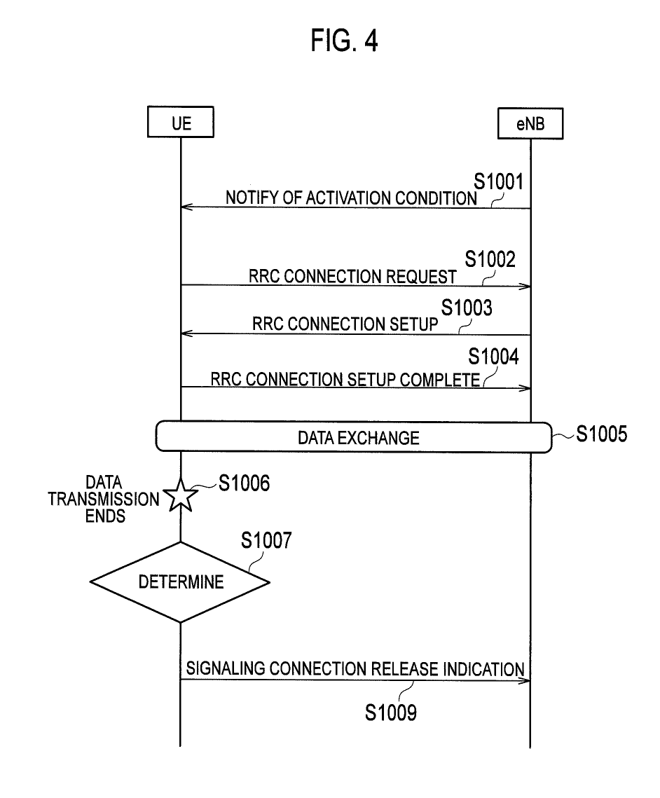

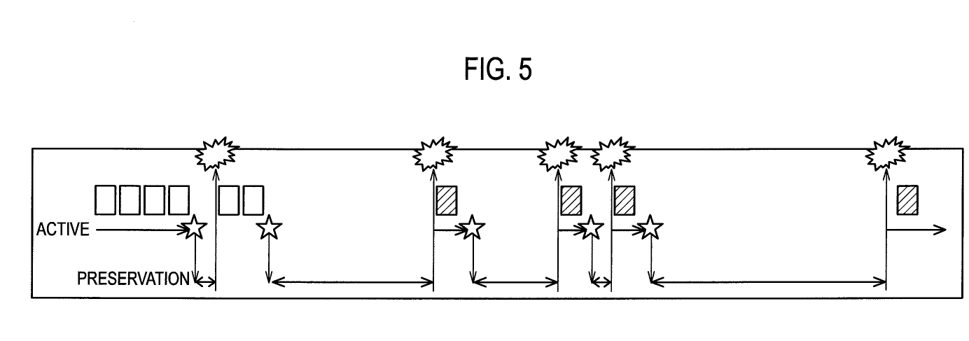

Operation of the mobile communication system according to this embodiment is described below with reference to FIG. 4.

As shown in FIG. 4, in Step S1001, the radio base station eNB notifies the mobile station UE conditions for activating the “Fast Dormancy function” (e.g., the data amount, the transmission interval, the data type, and the predetermined period described above).

In Step S1002, the mobile station UE transmits “RRC CONNECTION REQUEST” to the radio base station eNB. In Step S1003, the radio base station eNB transmits “RRC CONNECTION SETUP” to the mobile station UE. In Step S1004, the mobile station UE transmits “RRC CONNECTION SETUP COMPLETE” to the radio base station eNB.

Thereafter, in Step S1006, data exchange is performed between the mobile station UE and the radio base station eNB.

Upon detecting in Step S1006 that there is no more data to be transmitted, the mobile station UE determines in Step S1007 whether or not to transmit “SIGNALLING CONNECTION RELEASE INDICATION,” as described above.

For example, the mobile station UE may determine that the mobile station UE should transmit the “SIGNALLING CONNECTION RELEASE INDICATION” when determining that the mobile station UE is not in the particular state and when the predetermined period has passed after the transmission of the “RRC CONNECTION REQUEST.”

In Step S1008, when determining that the mobile station UE should transmit “SIGNALLING CONNECTION RELEASE INDICATION,” the mobile station UE transmits “SIGNALLING CONNECTION RELEASE INDICATION” to the radio base station eNB.

According to an invention according to this embodiment, the mobile station UE is configured to transmit “SIGNALLING CONNECTION RELEASE INDICATION” when the mobile station UE determines that the mobile station UE is in the particular state and when the predetermined period has passed after the transmission of “RRC CONNECTION REQUEST.” Hence, in a state where, for example, the mobile station UE is performing data exchange accompanied by user operation, the mobile station UE does not transition to the “Preservation state.” Thus, wasteful, repetition of transition to the “Preservation state” and return to the “Active state” is avoided to enable avoidance of occurrence of hasty control and avoidance of an increase in the amount of unnecessary signals.

The features of the above-described embodiment may also be expressed as follows.

A first feature of this embodiment is summarized as a mobile station UE including: a transmission unit 13 configured to transmit a “SIGNALLING CONNECTION RELEASE INDICATION (a release indication signal)” to a radio access network (a radio base station eNB) upon detecting that there is no more data to be transmitted, the “SIGNALLING CONNECTION RELEASE INDICATION” commanding release of signalling connection; and a determination unit 12 configured to determine whether the mobile station UE is in a particular state or not. Here, the transmission unit 13 is configured to keep the “SIGNALLING CONNECTION RELEASE INDICATION” from being transmitted to the radio access network (radio base station eNB) if the determination unit 12 determines that the mobile station UE is in the particular state, even when the transmission unit 13 detects that there is no more data to be transmitted.

In the first aspect of this embodiment, the determination unit 12 may be configured to determine whether the mobile station UE is in the particular state or not based on a data amount predetermined by the radio access network (radio base station eNB).

In the first aspect of this embodiment, the determination unit 12 may be configured to determine whether the mobile station UE is in the particular state or not based on a transmission interval predetermined by the radio access network (radio base station eNB).

In the first aspect of this embodiment, the determination unit 12 may be configured to determine whether the mobile station UE is in the particular state or not based on a data type predetermined by the radio access network (radio base station eNB).

In the first aspect of this embodiment, the transmission unit 13 may be configured to keep the “SIGNALLING CONNECTION RELEASE INDICATION” from being transmitted to the radio access network (the radio base station eNB) until a predetermined period passes after the transmission of “RRC CONNECTION REQUEST (connection request signal),” even when the transmission unit 13 detects that there is no more data to be transmitted and when the determination unit 12 determines that the mobile station UE is not in the particular state.

In the first aspect of this embodiment, the predetermined period may be notified of via notification.

A second feature of this embodiment is summarized as a mobile station UE including a transmission unit 13 configured to transmit a “SIGNALLING CONNECTION RELEASE INDICATION (a release indication signal)” to a radio access network (a radio base station eNB) upon detecting that there is no more data to be transmitted, the “SIGNALLING CONNECTION RELEASE INDICATION” commanding release of signalling connection. Here, the transmission unit 13 is configured to keep the “SIGNALLING CONNECTION RELEASE INDICATION” from being transmitted to the radio access network (radio base station eNB) until a predetermined period passes after transmission of a “RRC CONNECTION REQUEST”, even when the transmission unit detects that there is no more data to be transmitted.

A third feature of this embodiment is summarized as a radio base station eNB capable of communicating with a mobile station UE configured to determine, based on whether the mobile station UE is in a particular state or not, whether or not to transmit a “SIGNALLING CONNECTION RELEASE INDICATION” commanding release of signalling connection upon detecting that there is no more data to be transmitted. Here, the radio base station eNB includes a transmission unit 22 configured to notify the mobile station UE of determination information via notification, the determination information being for the determination on whether or not the mobile station UE is in the above-described particular state or not.

In the third aspect of this embodiment, the above-described determination information is any one of a data amount, a transmission interval, and a data type.

In the third aspect of this embodiment, a radio base station eNB capable of communicating with a mobile station UE configured to keep a “SIGNALLING CONNECTION RELEASE INDICATION” commanding release of signalling connection from being transmitted until a predetermined period passes after transmission of an “RRC CONNECTION REQUEST” even upon detecting that there is no more data to be transmitted. The radio base station eNB includes a transmission unit 22 configured to notify the mobile station UE of the predetermine period via notification.

It should be noted that the foregoing operations of the mobile station UE and the radio base station eNB may be implemented by hardware, may be implemented by a software module executed by a processor, or may be implemented in combination of the two.

The software module may be provided in a storage medium in any format, such as a RAM (Random Access Memory), a flash memory, a ROM (Read Only Memory), an EPROM (Erasable Programmable ROM), an EEPROM (Electronically Erasable and Programmable ROM), a register, a hard disk, a removable disk, or a CD-ROM.

The storage medium is connected to a processor so that the processor can read and write information from and to the storage medium. Instead, the storage medium may be integrated in a processor. The storage medium and the processor may be provided inside an ASIC. Such an ASIC may be provided in the mobile station UE and the radio base station eNB. Otherwise, the storage medium and the processor may be provided as discrete components inside the mobile station UE and the radio base station eNB.

Hereinabove, the present invention has been described in detail by use of the foregoing embodiments. However, it is apparent to those skilled in the art that the present invention should not be limited to the embodiments described in the specification. The present invention can be implemented as an altered or modified embodiment without departing from the spirit and scope of the present invention, which are determined by the description of the scope of claims. Therefore, the description of the specification is intended for illustrative explanation only and does not impose any limited interpretation on the present invention.

Note that the entire content of Japanese Patent Application No. 2012-057443 (filed on Mar. 14, 2012) is incorporated by reference in the present specification.

### INDUSTRIAL APPLICABILITY

As described above, the present invention can provide a mobile station and a radio base station capable of avoiding hasty control occurring due to repetition of transition to a “Preservation state” and return to an “Active state.”

### EXPLANATION OF THE REFERENCE NUMERALS

UE mobile station
eNB radio base station
11, 23 reception unit
12 determination unit
13, 22 transmission unit
21 control unit

1. A mobile station comprising:
a transmission unit configured to transmit a release indication signal to a radio access network upon detecting that there is no more data to be transmitted, the release indication signal commanding release of signalling connection; and
a determination unit configured to determine whether the mobile station is in a particular state or not, wherein
the transmission unit is configured to keep the release indication signal from being transmitted to the radio access network if the determination unit determines that the mobile station is in the particular state, even when the transmission unit detects that there is no more data to be transmitted.

2. The mobile station according to claim 1, wherein
the determination unit is configured to determine whether the mobile station is in the particular state or not based on a data amount predetermined by the radio access network.

3. The mobile station according to claim 1, wherein
the determination unit is configured to determine whether the mobile station is in the particular state or not based on a transmission interval predetermined by the radio access network.

4. The mobile station according to claim 1, wherein
the determination unit is configured to determine whether the mobile station is in the particular state or not based on a data type predetermined by the radio access network.

5. A mobile station comprising
a transmission unit configured to transmit a release indication signal to a radio access network upon detecting that there is no more data to be transmitted, the release indication signal commanding release of signalling connection, wherein
the transmission unit is configured to keep the release indication signal from being transmitted to the radio access network until a predetermined period passes after transmission of a connection request signal, even when the transmission unit detects that there is no more data to be transmitted.

6. A radio base station capable of communicating with a mobile station configured to determine, based on whether the mobile station is in a particular state or not, whether or not to transmit a release indication signal commanding release of signalling connection upon detecting that there is no more data to be transmitted, the radio base station comprising
a transmission unit configured to notify the mobile station of determination information via notification, the determination information being for the determination on whether or not the mobile station is in the particular state or not.

7. The radio base station according to claim 6, wherein
the determination information is any one of a data amount, a transmission interval, and a data type.

8. A radio base station capable of communicating with a mobile station configured to keep a release indication signal commanding release of signalling connection from being transmitted until a predetermined period passes after transmission of a connection request signal even upon detecting that there is no more data to be transmitted, the radio base station comprising
a transmission unit configured to notify the mobile station of the predetermine period via notification.
